(19) United States
(12) Patent Application Publication
(10) Pub. No.: US 2025/0377283 A1
(43) Pub. Date: Dec. 11, 2025

(54) METHODS OF PARTICLE SHAPE CHARACTERIZATION

(71) Applicant: Purdue Research Foundation, West Lafayette, IN (US)

(72) Inventors: Paul R. Mort, Lafayette, IN (US); Langdon A. Feltner, North Vernon, IN (US)

(21) Appl. No.: 19/235,362

(22) Filed: Jun. 11, 2025

Related U.S. Application Data
(60) Provisional application No. 63/658,582, filed on Jun. 11, 2024.

(51) Int. Cl. G01N 15/14; G06T 3/403; G06T 7/00; G06T 7/13; G06T 7/50; G06T 7/64

(52) U.S. Cl. CPC G01N 15/1456; G06T 3/403; G06T 7/0004; G06T 7/13; G06T 7/50; G06T 7/64; G01N 2015/1493; G01N 2015/1497; G06T 2207/20016; G06T 2207/20081; G06T 2207/30108

(57) ABSTRACT

Methods of particle shape and size characterization of powder particles include imaging the particles at a pixel-scale resolution to acquire images of the particles in which perimeter irregularities appear, increasing the resolution of the images and then performing fine-graining analysis on the images to accentuate at least some of the perimeter irregularities, calculating aspect ratios and elliptical form factors of the particles from the images; and determining the perimeter irregularities of the particles and elongation of the particles by mapping particles on an aspect ratio versus elliptical form factor plane to decouple the perimeter irregularities of the particles from the elongation of the particles and yield a statistical description of shapes of the particles.

### CROSS-REFERENCE TO RELATED APPLICATIONS

This application claims the benefit of U.S. Provisional Application No. 63/658,582 filed Jun. 11, 2024, the contents of which are incorporated herein by reference.

### BACKGROUND OF THE INVENTION

The present invention generally relates to methods of particle shape and size characterization. In particular, the invention encompasses fine-graining image analysis techniques adapted to identify and/or sort particles to obtain powders that are capable of exhibiting desirable flow and packing characteristics that can render the powders suitable for various uses, including but not limited to, powder-bed additive manufacturing, pharmaceutical tableting, battery cathode materials, and shot peening.

With advances in digital imaging technologies, size and shape analyses are becoming more routine for many applications. Technical advances in dynamic imaging have enabled routine sampling and analysis of particle shape and shape distributions. Size and shape distributions are relevant to many particulate processes involving flow, spreading, packing, and densification. Powder bed additive manufacturing is a particular example that requires uniform spreading, packing, and sintering of fine metal powders. Though there are contradictions regarding the terminology and analysis used to assess particle shape and shape distributions, guidance is available under the International Standards Organization (ISO, 2008).

Particle size distributions have been shown to have a significant effect on the mechanical properties and surface finish of additively manufactured parts. There is also precedence that the morphology of a powder influences the outcome of a process in which the powder is used. This influence has been attributed to size and shape distributions affecting powder spreading performance, leading to non-uniform layer thicknesses in some cases. It is therefore very desirable to be able to accurately and repeatably characterize the particle size and shape distribution of additive powders consistently across a desired size distribution in order to predict and control an additive manufacturing process.

The effects of digital image resolution and pixilation on shape results and the uncertainty thereof have been studied. Studies have concluded that the computation of particle perimeter and shape factors that utilize perimeter are especially affected by relatively coarse pixel scales. Most commonly used commercial and open source vision packages calculate a smoothed perimeter measurement, rather than summing the total length of pixel edges. If not explicitly defined as such, such a technique is analogous to Cauchy-Crofton smoothing, relying on numerical integration to calculate an approximate curve length. The effect of bounding surface construction on the precision of the Cauchy-Crofton computation has also been explored, with the conclusion that irregular surfaces require a higher degree of detail to accurately compute the length or area. The particle's area is computed as the sum of pixels below a threshold grayscale value. When this area is compared with a smoothed perimeter, inconsistencies can arise, especially at low pixel counts, leading to a measured area that is illogical for a smoothed perimeter. This means that the area to perimeter ratio is higher than for a perfect circle and yields shape factors that are illogical, or greater than one. This phenomenon is an artifact of inaccurate perimeter measurements. Overall, though high resolution is desired for robust imaging and analysis; this is an inherent challenge for particle distributions having significant dispersity in size and shape features.

In view of the above, there is an ongoing need to be able to illustrate and understand the effects of image analysis uncertainty across a distributed set of size and shape characteristics, with a goal of enabling high-resolution shape characterization over a size distribution, which in turn could enable industries to use shape characterization data to better describe their end-to-end powder processing, i.e., in terms of process-structure-property-performance relations, where particle shape is an important aspect of structure.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of particle shape and size characterization.

According to a nonlimiting aspect of the invention, a method of particle shape and size characterization of powder particles includes imaging the particles at a pixel-scale resolution to acquire images of the particles in which perimeter irregularities appear, increasing the resolution of the images and then performing fine-graining analysis on the images to accentuate at least some of the perimeter irregularities, calculating aspect ratios and elliptical form factors of the particles from the images; and determining the perimeter irregularities of the particles and elongation of the particles by mapping particles on an aspect ratio versus elliptical form factor plane to decouple the perimeter irregularities of the particles from the elongation of the particles and yield a statistical description of shapes of the particles.

Technical effects of methods as described above preferably include the ability to utilize fine-graining image analysis technology to improve two-dimensional (2D) particle image resolution for shape analysis, including shape factors depending on perimeter and convex-hull measurements. Such a capability can benefit a wide range of powder processing applications that involve flow and/or packing of powders, as nonlimiting examples, spreading and packing powders used in powder-bed additive manufacturing, achieving more consistent handling and die-filling of powders used in pharmaceutical tableting, achieving improved spreading and compaction of powders used as battery cathode materials, and obtaining powder particles whose shapes and sizes are better characterized for use in shot peening processes. The methods described above are further preferably capable of enabling high-resolution shape characterization over a particle size distribution, i.e., using fine graining to achieve comparable resolution across a broader range of sizes, which in turn can be used to enable industries to use shape characterization data to describe their end-to-end powder processing, i.e., in terms of process-structure-property-performance relations, where particle shape is an important aspect of structure.

Other aspects and advantages of this invention will be appreciated from the following detailed description.

### BRIEF DESCRIPTION OF THE DRAWINGS

FIG. 1 schematically represents an apparatus for performing a dynamic image analysis process.

FIGS. 2A and 2B represent image analysis descriptors used to analyze particles in a dynamic image analysis process according to certain aspects of the invention. In FIG. 2A, the descriptors are identified in a grayscale particle image with perimeter thresholding (edge pixels and interior corners), and FIG. 2B represents a thresholded image with a minimum Feret bounding box (with dimensions x_{LF} and x_{Fmin}) surrounding the particle and convex-hull areas (A_{CH}) of the particle.

FIG. 3 graphically represents a principal component analysis of particle shape descriptors that were determined for two samples of particles produced by gas atomization (GA) and cold mechanical processing (CMP) processes.

FIGS. 4A and 4B graphically represent particle size distributions with log-normal fitting parameters for the gas-atomized (GA) particle sample and cold mechanical processed (CMP) particle sample on the basis of the volume of the particles (FIG. 4A) and the cumulative number of the particles (FIG. 4B).

FIGS. 5A through 5C graphically represent volume-basis shape distributions of the GA and CMP particle samples based on aspect ratio (FIG. 5A), elliptical form factor (FIG. 5B), and form factor (FIG. 5C).

FIGS. 6A and 6B graphically represent particle shape feature mapping for, respectively, particles taken from the GA and CMP samples. Volume-basis densities are indicated by grayscale contours.

FIG. 7 depicts coarse-graining analysis of a particle from the CMP sample by area of gray-scale images with perimeter threshold pixels identified for edges and interior corners), representing shape distribution modes of AR_{box}=0.78, EFF=0.90 (top row) and AR_{box}=0.62, EFF=0.81 (bottom row).

FIG. 8 depicts examples of coarse graining analysis and machine-learning reconstruction using fine-graining analysis of thresholded images of particles taken from the GA and CMP samples. The particles are labeled A-D corresponding to their identification in FIGS. 6A and 6B.

FIGS. 9A and 9B graphically represent coarse-graining analysis of form factors of the GA and CMP particle samples relative to the reference ISO definition (FIG. 9A) and bounding box ratio (FIG. 9B).

FIGS. 10A and 10B graphically represent coarse-graining analysis of aspect ratios of the GA and CMP particle samples relative to the reference ISO definition (FIG. 10A) and bounding box ratio (FIG. 10B).

FIG. 11 graphically represents coarse-graining analysis of intra-particle porosity of the GA and CMP particle samples relative to the reference.

FIG. 12 graphically represents shape factor uncertainty of the GA and CMP particle samples with pixilation.

FIGS. 13 and 14 schematically represent systems and processes by which the benefits of a fine-graining analysis process could benefit.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of the embodiment(s) depicted in the drawings. The following detailed description also identifies certain but not all alternatives of the depicted embodiment(s). Therefore, the appended claims, and not the detailed description, are intended to particularly point out subject matter regarded as the invention, including certain but not necessarily all the aspects and alternatives described in the detailed description.

The following disclosure describes methods of quantitatively representing particle shapes per ISO specifications, and considers two aspects for improvement thereof: reduced-order mapping of shape distributions using PCA (principal component analysis) of shape descriptors; and uncertainty of shape distribution statistics based on pixel resolution.

Investigations leading to the present invention encompassed a case study of particle size and shape analysis using dynamic imaging of two powdered metal samples intended for use in powder bed fusion (PBF), which is a known method of additive manufacturing (AM). One sample was produced by gas atomization (GA), the other by cold mechanical processing (CMP), a precise size-reduction process. These methods of production affect the size and shape distributions. Classification of particles in terms of size and shape can be utilized to improve the reproducibility of PBF processes, as particle size and shape impact powder flow, bed packing, and optical interactions with lasers used to locally melt a powder material. Particle image data were collected using a commercial Dynamic Imaging Analysis (DIA) system. The raw data, in the form of 8-bit grayscale digital images, were analyzed in more detail to determine the effects of pixel scale resolution on shape descriptors. The data were then compared and contrasted for each sample, and the effect of pixel-scale resolution on the comparison was considered.

A principal component analysis of shape descriptors showed that over 90% of differences within the samples used in the study could be explained on the basis of elongation of a particle and perimeter irregularities of a particle, i.e., bumpiness or angularity. The ISO-standard Form Factor captures a combination of these two characteristics and can be used to indicate about 60% of the differences using a single shape factor. The study included a detailed analysis of pixel-scale resolution on principal shape descriptors.

Characterization of porosity is also important in many applications. Porosity can be associated with individual particles (intra-particle, ε_tra) as well as interstitial voids within a quantity of packed particles (inter-particle voids, ε_ter). Metal powder additive manufacturing typically seeks to eliminate porosity, hence there is interest in correlating porosity with particle shape characteristics. Therefore, the study also explored the relationship between intra-particle porosity and perimeter concavity from image analysis. Machine learning (ML) for fine-grain image reconstruction was utilized for this purpose.

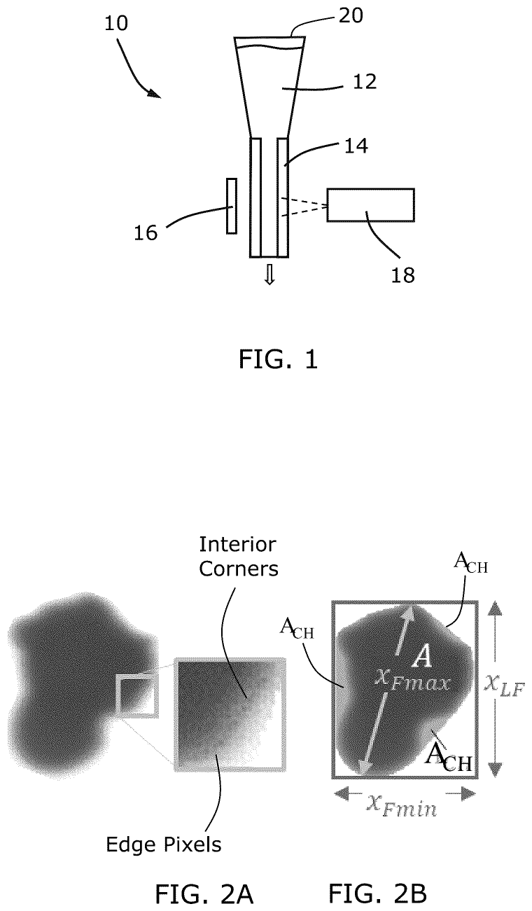

For the study, fine metal powders comprising 7075 aluminum alloy were obtained from two commercial vendors. A gas atomized (GA) sample was made by melting-gas atomization, and a second sample was made via a cold mechanical processing (CMP) described in U.S. Patent Publication No. 2021/0146442. Both samples were measured in a liquid-dispersion flow-through imaging system commercially available from InFlow™, JM Canty, Lockport, NY, USA), schematically represented in FIG. 1. The system 10 delivers a powder 12 through a vertical passage within an imaging cell 14 while subjected to an LED strobe 16 that provided an exposure time of 20 μs and an image resolution of 0.34 μm/pixel. A camera 18 captured two-dimensional (2D) projections of the powder particles, which were randomly oriented in a suspension flow through the passage 14, i.e., dynamic image analysis. For data acquisition and analysis of size and shape features, the system 10 employed NI Vision (National Instruments, Austin, TX, USA). The InFlow™ system 10 operated with software that had an option to save 8-bit grayscale digital bitmaps of all particles; which was used for detailed analysis of the effects of pixilation on shape conducted in the study.

Samples of the metal powders were prepared by placing about 0.5 g of each powder in a glass vial, and then adding several drops of iso-propyl alcohol (IPA) as a surface-wetting agent. The IPA had a secondary function of being an anti-foam agent. About 10 ml of an aqueous diluent was added to make a suspension of each metal powder. The diluent comprised 4% hydroxypropyl cellulose (HPC Klucel, obtained from Ashland Chemical, Wilmington, DE, USA) as a thickening agent. The viscosities of the metal powder suspensions were increased to about 0.3 Pa·s for the purpose of reducing the settling speed of the particles and stabilizing the dilution control loop. The suspensions were mixed while avoiding generation of air bubbles.

The metal powder suspensions were placed in a reservoir 20 of the system 10 with a syringe to avoid generation of air bubbles. Dual peristaltic pumps are used to draw the sample suspensions though the imaging cell 14 according to a control loop objective of 0.2% screen area below the particle detection threshold. The threshold setting was 170 out of a grayscale of 0-255, i.e., pixels less than 170 were considered to be within a particle. Size and shape analyses conducted in the study were based on the following features of the particle images, which are illustrated in FIGS. 2A and 2B: area and convex-hull area (A and A_{CH}, respectively); perimeter (P) based on smoothing of the pixelated edge (FIG. 2A); Feret lengths (minimum (x_{Fmin}), orthogonal to the minimum (x_{LF}), and maximum (x_{Fmax}); area-equivalent size (x_{A}=\sqrt{4A/π}, derived from the area (A); and particle volume based on area (V=4A^{1.5}/(3\sqrt{π})).

Data filtering was performed on the basis of grayscale intensity (0-threshold) averaged over the particle area. Shape descriptors included aspect ratios (AR_{box}=x_{Fmin}/x_{LF}; AR_{ISO}=x_{Fmin}/x_{Fmax}) and form factors (ISO (FF) and elliptical (EFF)) where

$$\begin{matrix}FF = 4 π A / {P}^{2} \\ EFF = βπ A / {P}^{2} , β = {( \frac{1.5 ( 1 + {AR}_{box} )}{\sqrt{{AR}_{box}}} - 1 )}^{2}\end{matrix}$$

The elliptical form factor is analogous to the ISO-defined Form Factor (ISO, 2008) with the difference being that it compares the measured perimeter to an area-equivalent ellipse instead of a circle. Shape descriptors also included area ratios per ISO guidance: box area (BAR), extent (Ext), and solidity (S):

$$\begin{matrix}BAR = A / ( {x}_{F min} \cdot {x}_{LF} ) \\ Ext = A / ( {x}_{F min} \cdot {x}_{F max} ) \\ S = A / {A}_{CH}\end{matrix}$$

An estimate of intra-particle porosity was derived using a 2D-to-3D transformation of solidity:

$${ε}_{tra} = 1 - {S}^{1.5}$$

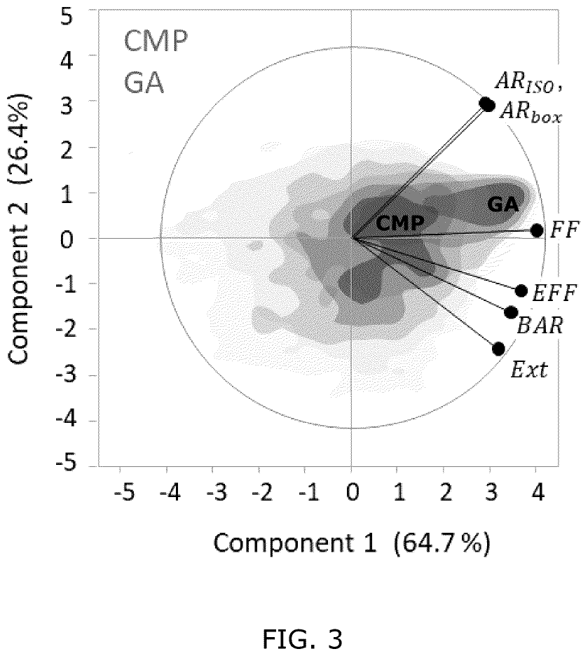

Principal component analysis (PCA) of shape descriptors was used to identify clusters and rank individual shape descriptors in terms of their effectiveness in shape differentiation (JMP, SAS Institute, Cary, NC, USA). The volume-weighted PCA included the combined data of GA (N=5629) and CMP (N=1086) particle samples having equivalent total particle volumes of 7.81E-2 mm³. The results represented in FIG. 3 evidenced that over 90% of shape effects could be described with two principal components. Clustering of shape descriptors by principal component (Table 1 below) indicated characteristic features for each component, EFF and AR_{box}, respectively. In the latter, AR_{ISO} has nearly the same effect as AR_{box}. Other shape descriptors, FF, Ext, and BAR, were clustered with EFF. AR_{box} and EFF were essentially sub-components of the standard form factor, FF. When shape descriptors were constrained to a single cluster, FF became the most representative; however, clustering all effects within a single component described only about 65% of the shape variance. Hence, the deconstruction of the form factor into elongation and perimeter irregularities of a particle provided a substantial improvement in the statistical description of particle shape.

TABLE 1
PCA cluster summary.

| Cluster | Members | R² within cluster | R² w/other cluster |
|---|---|---|---|
| 1 | EFF | 0.864 | 0.141 |
| | Ext | 0.810 | 0.018 |
| | BAR | 0.807 | 0.100 |
| | FF | 0.799 | 0.438 |
| 2 | AR_{box} | 0.991 | 0.164 |
| | AR_{ISO} | 0.991 | 0.169 |

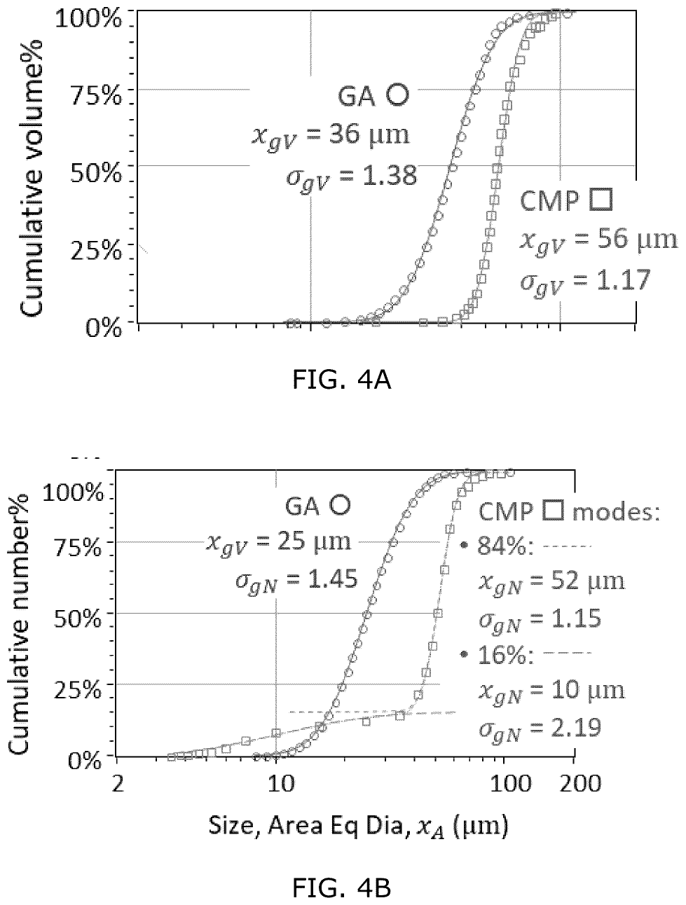

Size distribution analysis was performed using a weighted regression method. The log-normal fits shown in FIGS. 4A and 4B revealed significant differences in size distributions of the two samples, where the fit parameters relate to cumulative distribution functions (cdf_{LN}) per Equation (1). Compared to the GA sample, CMP was larger in size and narrower in distribution when viewed as a volume-basis distribution (FIG. 4A). The number basis distribution had a bimodal fines tail in the CMP sample, but not in GA. While the CMP processing and any subsequent classification step was apparently highly efficient on a volume basis, the number distribution revealed a trace residue of fines, which is typical of a milling-classification process such as CMP.

$${cdf}_{LN} = \frac{1}{2} \cdot ( 1 + erf ( \frac{ln ( x / {x}_{g} )}{\sqrt{2} \cdot ln ( {σ}_{g} )} ) ) \qquad ( 1 )$$

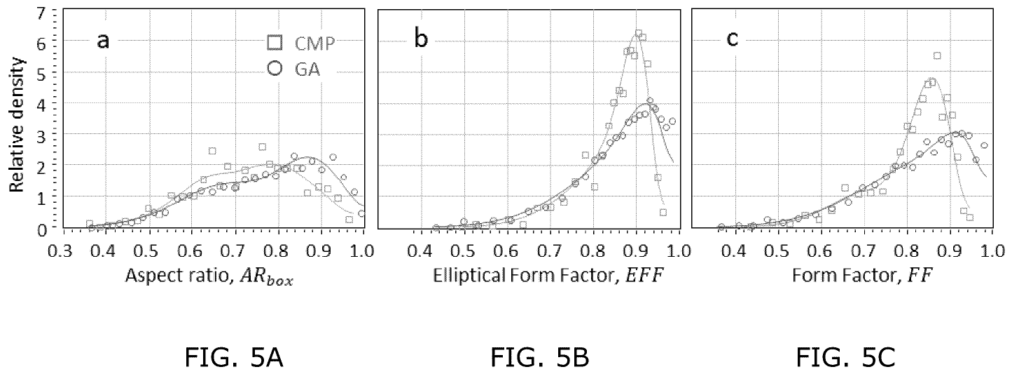

The weighted regression method was also used to analyze shape distributions. Shape factors are dimensionless, and bounded between 0 and 1, (0,1]. Bimodal stretched-exponential distribution (i.e., Weibull) functions were used to model the shape data. Fit parameters in Table 2 (below) describe the shape distributions according to Equation (2), where the modes are summed to describe stretched-exponential cumulative distribution functions (cdf_{SE}) on a volume basis. Density plots in FIGS. 5A, 5B, and 5C are the derivatives of the cumulative data with respect to ln(x).

$${cdf}_{SE} = 1 - exp ( - ( x / {x}^{{* )}^{n}} ) \qquad ( 2 )$$

TABLE 2

| | | AR_{box} | | | EFF | | | FF | | |
|---|---|---|---|---|---|---|---|---|---|---|
| Sample | mode | vol % | x* | n | vol % | x* | n | vol % | x* | n |
| GA | 1 | 63% | 0.87 | 9.7 | 47% | 0.93 | 18.6 | 33% | 0.93 | 18.2 |
| | 2 | 37% | 0.64 | 7.3 | 53% | 0.82 | 7.9 | 67% | 0.80 | 6.8 |
| CMP | 1 | 86% | 0.78 | 6.4 | 60% | 0.9 | 26.3 | 77% | 0.86 | 17.3 |
| | 2 | 14% | 0.62 | 10.7 | 40% | 0.81 | 10.2 | 23% | 0.67 | 10.2 |

Comparing the two samples, the GA sample had marginally higher mode values (x*) for all three features indicating more rounded morphology; however, there was a broad overlap over the full distributions. The CMP sample had discernably sharper peaks (higher weighted n) within the density distributions, suggesting the process created a tight distribution.

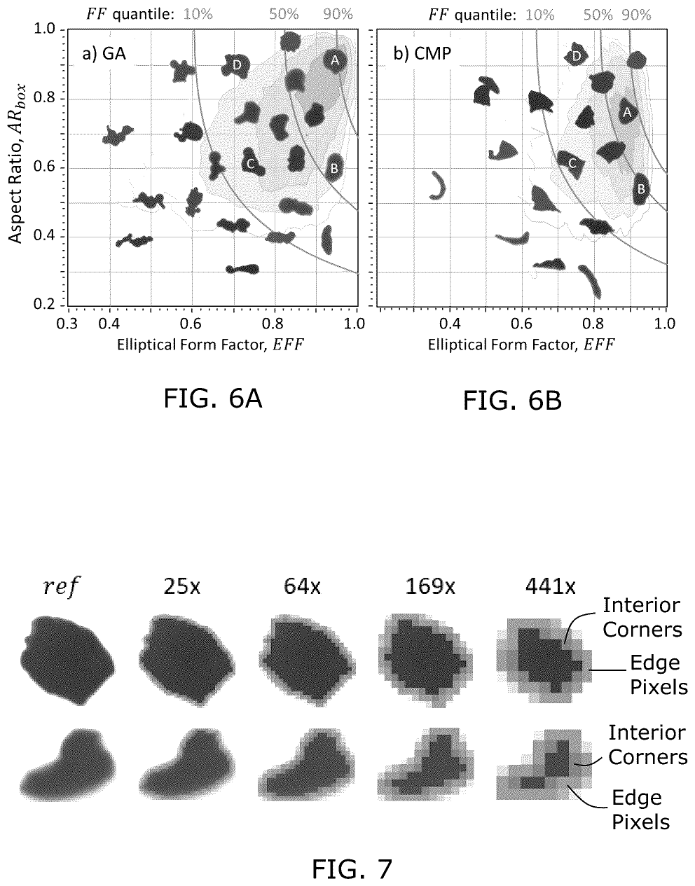

The orthogonal relationship between aspect ratio (AR) and the elliptical form factor (EFF) enabled graphical mapping of shape factors using contours, as graphically represented in FIGS. 6A and 6B. A value of (1,1) is a circle, i.e., a 2D projection of a spherical particle. Decreasing values along the ordinate correspond to shape elongation. Decreasing abscissa values indicate perimeter irregularities such as bumpiness or angularity. Grayscale contours indicate sample density. Line contours are Form Factor quantiles. The maps are illustrated by thresholded grayscale images showing differences and trends for each sample. Objectively, shape factors in and of themselves did not necessarily differentiate between the samples, i.e., GA versus CMP. Visual imaging added value to the analysis.

In the above analysis, most particles had high pixel resolution. In the GA sample, the number and volume-weighted geometric averages were 4300 and 8800 pixels/particle, respectively. In the CMP sample, the number and volume-weighted geometric averages were 11,800 and 22,400, respectively. High-resolution imaging provided confidence in shape analysis.

The study then investigated the effect of pixel resolution on shape analysis. Taking the high-resolution data as a reference, systematic coarse-graining was done to reduce pixel-scale resolution, following a Fibonacci sequence: 2, 3, 5, 8, 13, 21 . . . , resulting in reduced pixilation by factors of 4, 9, 25, 64, 169, and 441+, to a limit of about 10 pixels/particle. Coarse graining is illustrated in FIG. 7 using two example particles (top row and bottom row in FIG. 7) from the CMP sample. These examples were chosen according to modes of the shape distribution described in Table 2, and evidence that perimeter irregularities (such as bumpiness or angularity) were accentuated by coarse graining.

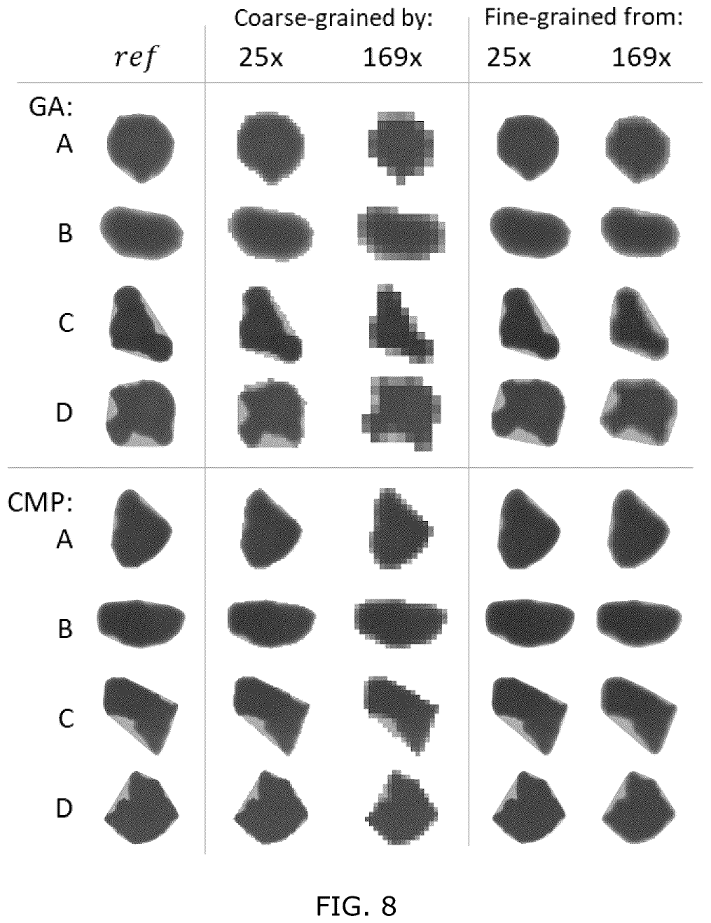

Individual reference particles were selected for each sample, covering the shape distribution map (particles labeled as A, B, C, and D in FIGS. 6A and 6B). In FIG. 8, thresholded grayscale images are shown for each reference (A-D) along with additional convex-hull areas (A_{CH}) in lighter shading. Examples of coarse graining by area (25×, 169×) illustrate the effect of pixel scale resolution on the convex hull. In reference cases having only small amounts of concavity (i.e., A, B; having high EFF on the map), convex-hull area was eliminated by coarse graining. In cases having more concavity (i.e., C, D; low EFF), convex hull persisted, but was eventually eliminated by extreme coarse-graining.

In an effort to improve precision of shape descriptors, a fine-graining method was developed using machine learning (ML). Selected fine-graining results are shown in FIG. 8, essentially reconstructing the reference from the coarsened images produced by the coarse-graining analysis.

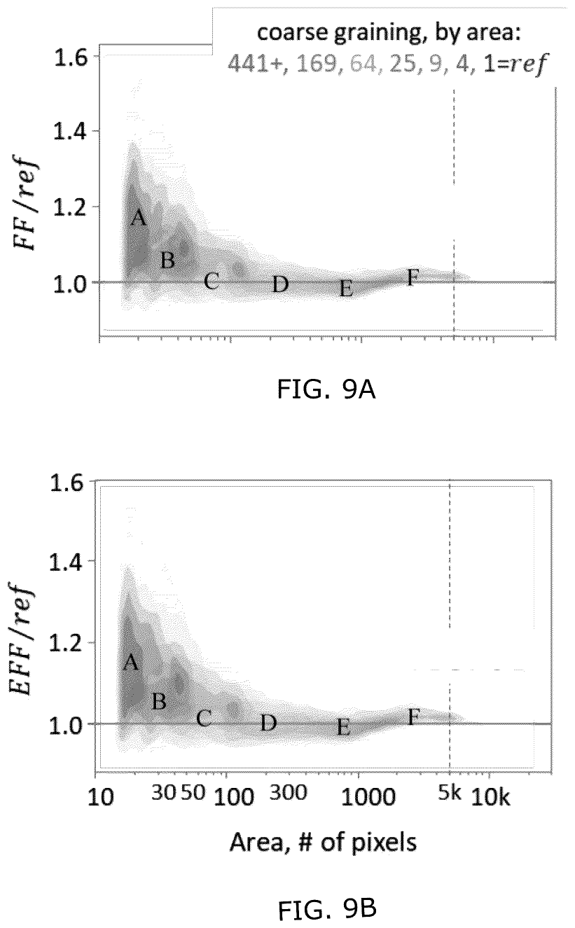

Ensemble results for selected shape factors are shown as contour plots in FIGS. 9A, 9B, 10A, 10B, and 11. The reference data set had about 7,600 particles; the coarse-grained set had about 40,000, combining both GA and CMP samples. Regions of the plots corresponding to the pixilation factors of 4, 9, 25, 64, 169, and 441+ are identified as, respectively, A, B, C, D, E, and F in FIGS. 9A, 9B, 10A, 10B, and 11. The reference line at 1.0 on the ordinate indicates consistency with the raw data; deviation from the 1.0 reference shows the effect of reduced pixel scale resolution on shape analysis. The vertical dashed line at 5000 (5 k) particles indicates the ISO guidance for robust perimeter-based shape measures. Below this, uncertainty in smoothing the pixelated perimeter is inherited in the shape analysis. Under-estimation of the perimeter results in over-estimation of Form Factors; in some cases, illogical Form Factors (i.e., >1) may result.

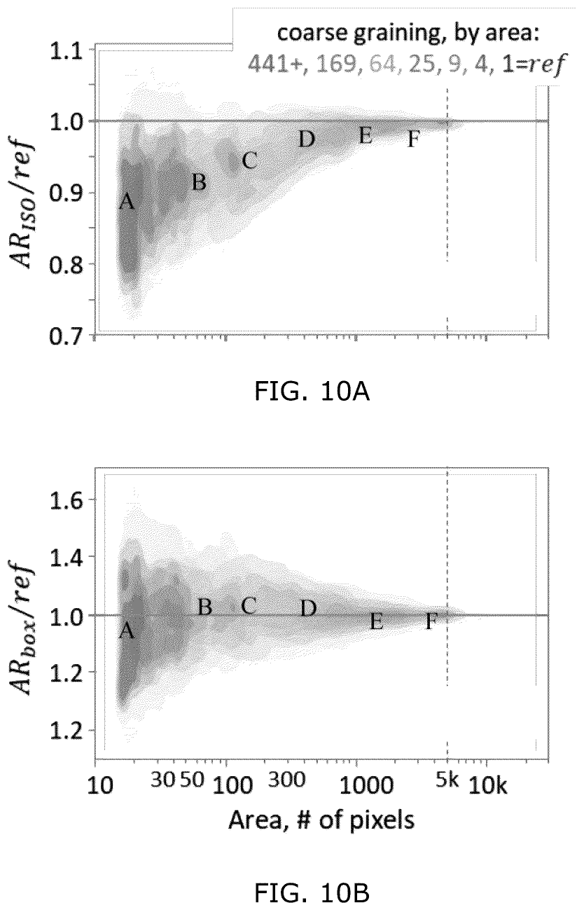

FIGS. 9A and 9B confirmed uncertainty related to perimeter smoothing. With NI-Vision, uncertainty is reasonably balanced as low as about 300 pixels. However, at lower resolutions, a significant skew toward under-estimated perimeters (i.e., over-estimated Form Factors) was observed. Pixel-scale uncertainty also affected aspect ratios (FIGS. 10A and 10B). While the bounding box ratio was reasonable balanced (FIG. 10B), the ISO-defined aspect ratio showed a significant skew with even small amounts of coarse graining, suggesting a systematic bias toward maximum Feret lengths with coarser pixilation.

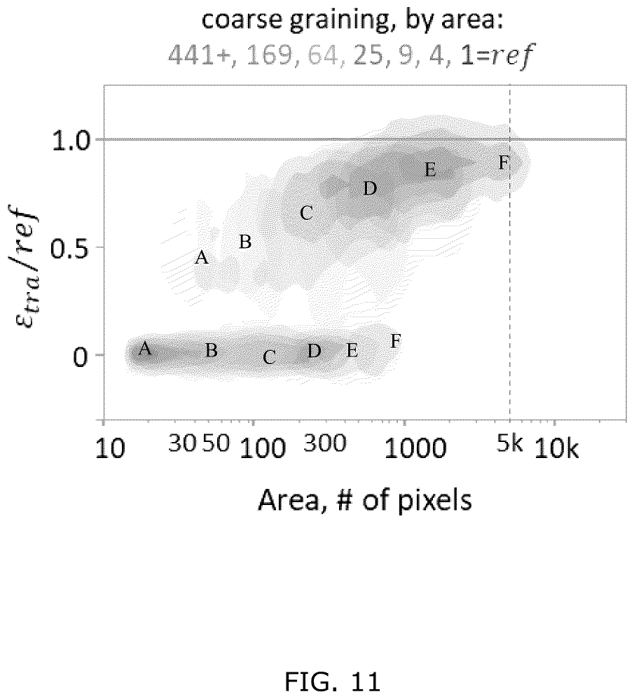

The effect of pixilation on intra-particle porosity derived from Solidity was more profound, as evidenced in FIG. 11. The results were bimodal, showing the porosity estimate of many particles dropping to zero with increasing pixilation, i.e., loss of concavity with pixilation. This effect was most severe with particles having only small amounts of concavity in the reference condition. Concavity was more persistent in reference particles that had more significant reference porosity.

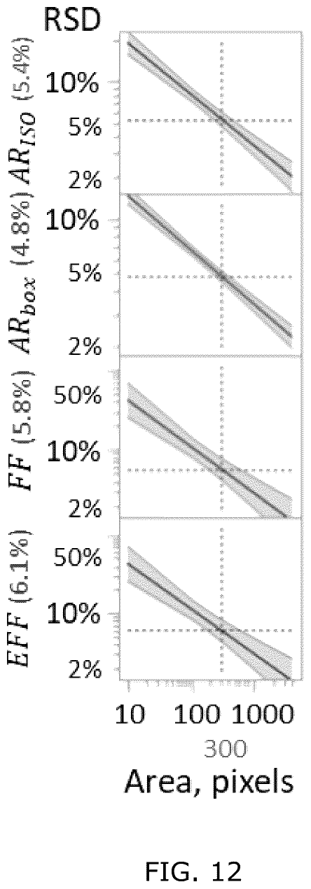

FIG. 12 represents an ensemble summary of pixilation uncertainty evaluated using the standard deviation of each shape factor as a function of the degree of coarse graining. The relative standard deviation was calculated by normalizing the volume-weighted standard deviation to the reference. A power law trend is generally followed in FIG. 12, showing RSD uncertainty in the range of about 5-6% at 300 pixels/particle. The confidence limits were tightest for the bounding box aspect ratio, AR_{box}, and marginally looser for the Form Factors. On one hand, this was consistent with ISO guidance regarding uncertainty of perimeter measures; on the other hand, it suggested opportunities for improved perimeter-measurement algorithms.

From the study, it was concluded that shape descriptor uncertainty depended on pixilation. For shape distribution statistics performed with the fine-graining analysis, pixel-scale resolutions as low as about 300 pixels/particle were able to provide reasonable accuracy, within a relative standard deviation of about 5%. For the fine-graining analysis, the pixel resolution of the images should be increased by a factor of at least 4×, more preferably by at least 9×, in relation to the resolution of the initially acquired images. The primary limitation is robust calculation of particle perimeters; at low pixel resolution, perimeter calculations are both skewed and variable, resulting in the possibility of illogical form factor values, i.e., FF or EFF>1.0. Applying fine-graining analysis via machine learning (ML) can address this problem, maintaining logical form factors and enabling statistically-robust shape mapping across broader size ranges.

Shape mapping using aspect ratios and elliptical form factors was consistent with principal component analysis of the metal powder datasets. By definition, the elliptical form factor is orthogonal to the aspect ratio. Mapping particles on an AR versus EFF plane decoupled perimeter irregularities such as bumpiness or angularity from elongation. This was a useful method of visualizing differences between samples, and therefore the deconstruction of the form factor into elongation and perimeter irregularities of a particle provided a substantial improvement in the statistical description of particle shape.

Intra-particle porosity estimates, computed by way of convex-hull area (A_{CH}), were severely impacted with limited pixel counts. Hence, correlation with solidity under-represents intra-particle porosity at coarse pixel scales. While much of the concavity detail lost in coarse particle images can be recovered through image fine-graining, there is a possibility to over-correct compared to reference training data, suggesting whether a higher-resolution reference data may be beneficial in the context of correlating imaging descriptors with porosity. Selective implementation of machine learning-based image enhancement may offer consistency of shape analysis over broader ranges of particle size.

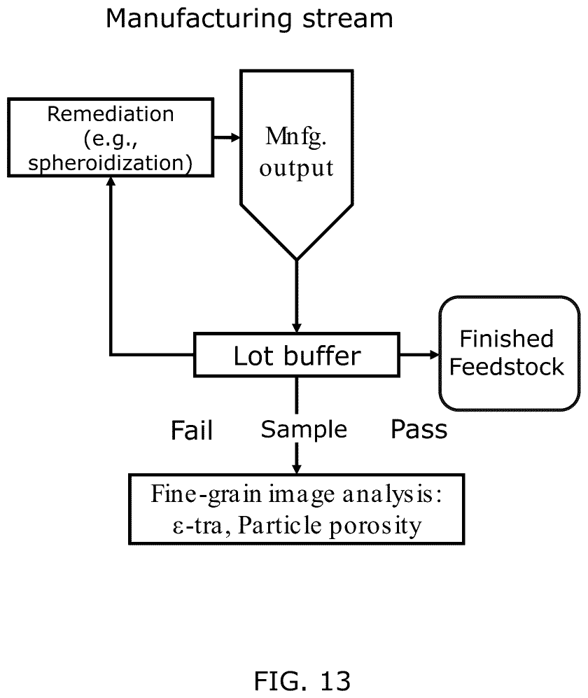

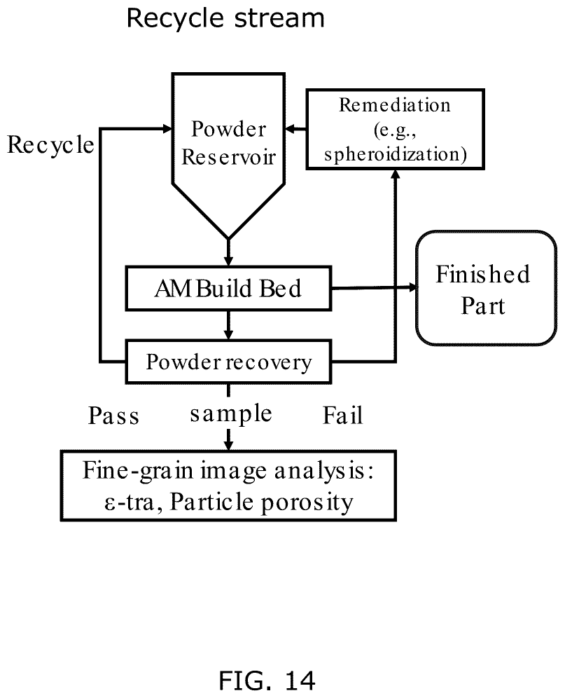

FIGS. 13 and 14 schematically represent systems and processes by which the benefits of a fine-graining analysis process as described above could benefit. In FIG. 13, the analysis is applied to a manufacturing process for powders, and FIG. 14 represents the analysis applied to a powder recycling process.

While the invention has been described in terms of a particular embodiment, it is apparent that other forms could be adopted by one skilled in the art. For example, though the investigation used lower resolution images produced by coarse-graining analysis, whose resolutions were then increased for performing the fine-graining analysis, it should be understood that the resolutions of images directly acquired by the imaging of particles can be increased to perform the fine-graining analysis, thereby omitting the coarse-graining analysis step. As such, and again as was previously noted, it should be understood that the invention is not necessarily limited to any particular embodiment described herein or illustrated in the drawings.

1. A method of particle shape and size characterization of powder particles, the method comprising:
imaging the particles at a pixel-scale resolution to acquire images of the particles in which perimeter irregularities appear;
increasing the resolution of the images and then performing fine-graining analysis on the images to accentuate at least some of the perimeter irregularities;
calculating aspect ratios and elliptical form factors of the particles from the images; and
determining the perimeter irregularities of the particles and elongation of the particles by mapping particles on an aspect ratio versus elliptical form factor plane to decouple the perimeter irregularities of the particles from the elongation of the particles and yield a statistical description of shapes of the particles.

2. The method according to claim 1, wherein the fine-graining analysis comprises performing machine learning to calculate the aspect ratios and elliptical form factors of the particles.

3. The method according to claim 1, wherein the resolution of the images is at least 300 pixels/particle when performing the fine-graining analysis.

4. The method according to claim 3, wherein the resolution of the images is increased by a factor of at least 4× for performing the fine-graining analysis.

5. The method according to claim 3, wherein the resolution of the images is increased by a factor of at least 9× for performing the fine-graining analysis.

6. The method according to claim 1, wherein the perimeter irregularities of the particles comprise bumpiness or angularity of the particles.

7. The method according to claim 1, further comprising, after performing the fine-graining analysis on the images, determining convex-hull areas of the particles from the images and determining intra-particle porosity therefrom.

8. The method according to claim 1, further comprising using training data acquired from the images acquired by imaging the particles to calculate the aspect ratios and the elliptical form factors of the particles.

9. The method according to claim 1, further comprising using the powder particles in a powder manufacturing process.

10. The method according to claim 1, further comprising using the powder particles in a powder recycling process.

11. The method according to claim 1, further comprising using the powder particles in a powder-bed additive manufacturing process, a pharmaceutical tableting process, as a battery cathode material, or a shot peening processes.
